(19) United States
(12) Patent Application Publication
(10) Pub. No.: US 2005/0157589 A1
(43) Pub. Date: Jul. 21, 2005

(54) Survey design using earth observation data

(76) Inventor: Andreas Laake, Kingston (GB)

Correspondence Address: SCHLUMBERGER RESERVOIR COMPLETIONS, 14910 AIRLINE ROAD, ROSHARON, TX, 77583, US

(21) Appl. No.: 11/037,699

(22) Filed: Jan. 18, 2005

Related U.S. Application Data
(60) Provisional application No. 60/537,780, filed on Jan. 20, 2004.

(51) Int. Cl. G01V 1/34

(52) U.S. Cl. 367/68

(57) ABSTRACT

A method for generating one or more maps of a survey area. The method includes receiving earth observation data, georeferencing the earth observation data with seismic data, extracting one or more attributes from the earth observation data and displaying the extracted attributes.

### CROSS-REFERENCE TO RELATED APPLICATIONS

This application claims benefit of U.S. provisional patent application Ser. No. 60/537,780, filed Jan. 20, 2004, which is incorporated herein by reference.

### BACKGROUND OF THE INVENTION

1. Field of the Invention

Embodiments of the present invention generally relate to seismic survey design, and more particularly, to quality control of seismic data.

2. Description of the Related Art

Quality control of surface seismic data is typically measured using source seismic data and receiver seismic data. Source seismic data is typically provided by a seismic source, such as a vibrator. An example of source seismic data that may be used for quality control is a seismic source signal wavelet, which is the time signal measured at several points of the vibrator. The time signal is indicative of data quality and is directly affected by ground conditions, such as elastic properties, gradient and composition of the earth's surface. For example, boulders often cause point loading of the vibrator baseplate, thereby leading to poor signal being transmitted into the ground. Parameters used for quality control include force, total harmonic distortion, and elasticity and stiffness. A high force typically indicates a high distortion, and hence, a low quality of source signal. If a vibrator is operated in feedback mode, force typically increases on soft ground. Total harmonic distortion is indicative of the fidelity of the source signal. Elasticity and stiffness provide estimates of the elastic behavior of the ground below the vibrator baseplate and are therefore ideal calibration parameters for seismic data quality.

Quality control of seismic data at the seismic receivers is typically measured in a recording truck immediately after recording. Quality of seismic data at the receivers is often affected by non-linearity of the source signal and receiver coupling conditions. In soft ground, geophone coupling to the ground may lead to resonance and, therefore, high distortion of the seismic data. In addition, ambient noise from installations and natural sources, such as wind and water, may degrade data quality. Parameters used for quality control at the seismic receivers include noise, total harmonic distortion, offsets and drifts. Data quality of source and receiver signals generally depends on the properties at the location where the measurements are taken.

Current seismic technology, however, performs quality control on seismic data at the source and receivers only after acquisition of seismic data. Accordingly, a need exists in the art for performing quality control on seismic data prior to acquisition of seismic data to provide an opportunity to avoid or compensate for potential problem locations.

### SUMMARY OF THE INVENTION

One or more embodiments of the invention are directed to a method for generating one or more maps of a survey area. The method includes receiving earth observation data, georeferencing the earth observation data with seismic data, extracting one or more attributes from the earth observation data and displaying the extracted attributes.

One or more embodiments of the invention are also directed to a method for planning a survey. The method includes receiving earth observation data, georeferencing the earth observation data with seismic data, extracting one or more attributes from the earth observation data, displaying the extracted attributes and using the maps to identify locations within the survey area that are prone to ground coupling problems for source and receivers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a method for generating one or more survey maps in accordance with one or more embodiments of the invention.

FIG. 2 illustrates a computer network, into which embodiments of the invention may be implemented.

### DETAILED DESCRIPTION

Estimation of surface characteristics from earth observation data (or satellite imagery) is an emerging technology. Earth observation data is useful for various purposes, including mapping of surface mineral deposits, flood monitoring and infrastructure planning. Satellites are typically equipped with sensors that measure reflected energy in visible-to-infrared wavelengths, radiated thermal infrared energy, and radar backscatter information about the earth's surface. Combining these data allows characterization of different types of surfaces. The algorithms for extracting certain surface characteristics are well known in the art.

Table 1 below gives an overview of the information that can be obtained from satellite imagery.

TABLE 1

| Wave type and band | Wavelength | | Surface feature |
|---|---|---|---|
| Visible bands (VIS) | 0.40-0.75 | m | Infrastructure, digital |
| | | | elevation model (DEM), |
| | | | water features |
| Near infrared bands (NIR) | 0.75-1.20 | m | Vegetation |
| Mid infrared bands (MIR) | 1.20-2.0 | m | Surface features |
| Short-wave infrared | 2.0-5.0 | m | Rock types |
| bands (SWIR) | | | |
| Thermal infrared bands | 5.0-13.0 | m | Lithology and mineralogy |
| (TIR) | | | |
| Microwave synthetic | 5.6 | cm | Moisture, texture |
| aperture radar (SAR) | | | |

The spectral bandwidth available from modern satellite imagery allows identification of surface obstacles as well as lithological and mineralogical surface characterization. Satellite imagery provides densely sampled maps of surface attributes, whereas seismic information only provides data along source and receiver lines. Processing and interpretation of seismic data, however, require spatially continuous data to create appropriate data models. This opens a range of opportunities for satellite imagery to extrapolate sparse surface seismic data with densely sampled earth observation data.

One or more embodiments of the invention are aimed at providing geographically accurate seismic quality maps that are based on surface and near-surface features compiled from a combination of satellite and derived data. In this manner, major areas of poor seismic data quality, such as sand dunes, sabkha, marshlands, caliche horizons and barren rock, can be mapped. Such maps are configured to reduce the risk of acquiring poor-quality seismic data. These maps may be used during survey design to provide data quality estimates, during acquisition to avoid problematic locations within the survey area and during data processing as a guide for interpolating the seismic data. The extent to which these maps may be used during survey design, acquisition and data processing will be discussed in more detail in the following paragraphs.

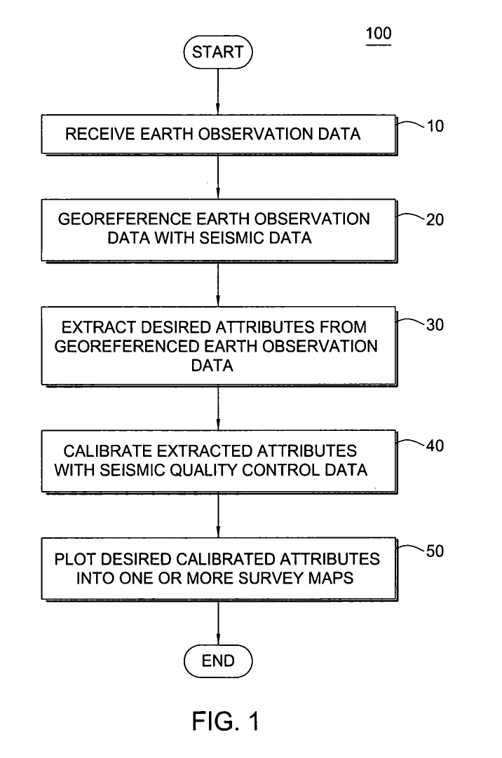

FIG. 1 illustrates a method 100 for generating one or more survey maps in accordance with one or more embodiments of the invention. At step 10, earth observation data or satellite imagery of a survey area is received. The earth observation data may be obtained from any source commonly known by persons of ordinary skill in the art. The earth observation data may be received as images in specific frequency bands ranging from visible light bands to thermal infrared bands. The earth observation data may also include radar data from synthetic aperture radar. At step 20, the earth observation data is georeferenced with seismic data. The earth observation data may be georeferenced by various methods commonly known by ordinary persons skilled in the art. Such methods typically include associating the pixel image data acquired by the earth observation camera with earth surface coordinates and warping the pixel image data according to the curvature of the earth's surface.

At step 30, a number of desired attributes from the earth observation data is extracted. In one embodiment, land use information, such as infrastructure, vegetation, rivers and mountains, and digital terrain model are extracted from the earth observation data. Digital terrain models, which are often referred to as digital elevation models, provide the topography and surface gradient of the survey area. Both infrastructure and digital terrain models are indicative of the safety and accessibility of the survey area for seismic data acquisition. For example, survey area with steep slopes, such as sand dunes, may hamper seismic data acquisition since the steep slopes may cause the seismic source, e.g., vibrator, to roll over. The digital terrain models therefore may be used to determine the surface gradient of a survey area and identify locations within the survey area that are inaccessible due to their steep gradient. In addition to safety and accessibility to the survey area, digital terrain models may also be indicative of locations within the survey area with poor data quality. That is, digital terrain models may be used to identify locations with steep slopes that may cause the vibrators to slide, and thereby compromising the quality of seismic data acquired at those locations. In one embodiment, locations with a slope exceeding a predetermined slope may be determined unsafe, inaccessible or conducive to poor data quality. Earth observation data obtained by visible, near and mid infrared may be used to identify land use information and digital terrain models.

Another set of attributes that may be extracted from the earth observation data includes objects, such as rocks or boulders, having diameters greater than 20 cm. Rocks or boulders that have less than 20 cm diameter typically do not pose a problem since they can be crushed or smashed into the ground by the vibrator. Rocks or boulders with diameters exceeding 20 cm, however, are indicative of locations within the survey area that may cause vibrator coupling and point loading problems, which typically occur when a vibrator baseplate is disposed on a rock or boulder. Such problems often result in high distortion of the transmitted signal due to inadequate coupling of the baseplate to the ground, which leads to poor vibrator signal quality, and severe damage to the baseplate. As such, rocks and boulders with diameters exceeding 20 cm may be used to identify locations within a survey area that are conducive to poor data quality. Earth observation data obtained by short wave infrared may be used to identify rocks and boulders.

Yet another set of attributes that may be extracted from earth observation data includes soft ground that would present coupling problems to the source or receivers. Soft ground is generally characterized by poor consolidation due to lack of binding agent between the grains composing the earth's surface. Examples of soft ground include drainage patterns, wadis, sand dunes, sabkha, gypsum, caliche horizons and the like. Earth observation data obtained by short wave infrared may be used to identify sand dunes. Earth observation data obtained by thermal infrared may be used to identify drainage patterns, wadis, sabkha, caliche horizons and gypsum.

At step 40, the extracted attributes are calibrated with seismic quality control data. Calibrating the attributes with seismic quality control data may include correlating the attributes with force and distortion data of the source signals and with characteristic surface wave velocity, attenuation, resonance, magnitude and spectral characteristic of the receiver signals.

At step 50, the extracted, calibrated attributes are plotted into one or more survey maps. In one embodiment, a visible light image map is generated. The visible light image map provides information regarding land use information, such as rivers, mountains, vegetation, infrastructure and the like. The visible light image map may be used to identify unsafe and inaccessible locations within a survey area. A permit is typically required for access into these locations.

In another embodiment, a synthetic aperture radar (SAR) derived roughness map may be generated. This second map is configured to illustrate rocks and boulders with diameters exceeding 20 cm, which are indicative of locations that may cause vibrator coupling and point loading problems.

In yet another embodiment, a surface lithology map may be generated. This third map is configured to illustrate soft ground areas that would present coupling problems to the source or receivers.

Once these maps are generated, they may be stored in a geographic information system (GIS) database. In one or more embodiments of the invention, these maps may be used during logistic planning, acquisition and data processing. Land seismic surveys typically require a substantial amount of logistic planning. The location and nature of surface features, such as rocks or sand, often play an important factor in efficient logistic planning. The logistic aspects of survey planning primarily address accessibility of the source and receiver points for vehicles and line crew. As such, during logistic planning, since the earth observation data provide high resolution information about the infrastructure and terrain on the survey area, these maps provide a tool for determining safe and accessible locations within the survey area. The maps may also aid in the optimization of survey design for data quality. That is, since the earth observation data provide information about the earth surface characteristics, the maps maybe used to identify locations within the survey area that are prone to coupling problems for the source and receivers. Further, in locations where no source or receivers can be placed, the maps may also serve as a guide to the selection of replacement source and receivers. These replacements are used in lieu of the originally planned source and receivers to provide better data quality by using a slightly different geometry.

During acquisition, the maps may be used to identify inaccessible and unsafe locations. In this manner, locations with a high risk of point loading and coupling problems to the source or receivers can be avoided during acquisition.

With respect to data processing, current acquisition technologies merely provide seismic data along source and receiver lines, and hence, i.e., only a mesh of data, instead of a densely sampled grid. Current data processing technologies typically use interpolation to fill the absence of data between the source and receiver lines, which often leads to incorrect interpolations and errors. The maps in accordance with various embodiments of the invention provide a densely sampled grid of surface and near-surface information from earth observation data, and thus allow interpolation of seismic data along topographic, geologic and lithologic features identified on the earth observation data. In this manner, the earth observation derived elastic property attributes may be used to fill the gaps in the seismic data between source and receiver lines.

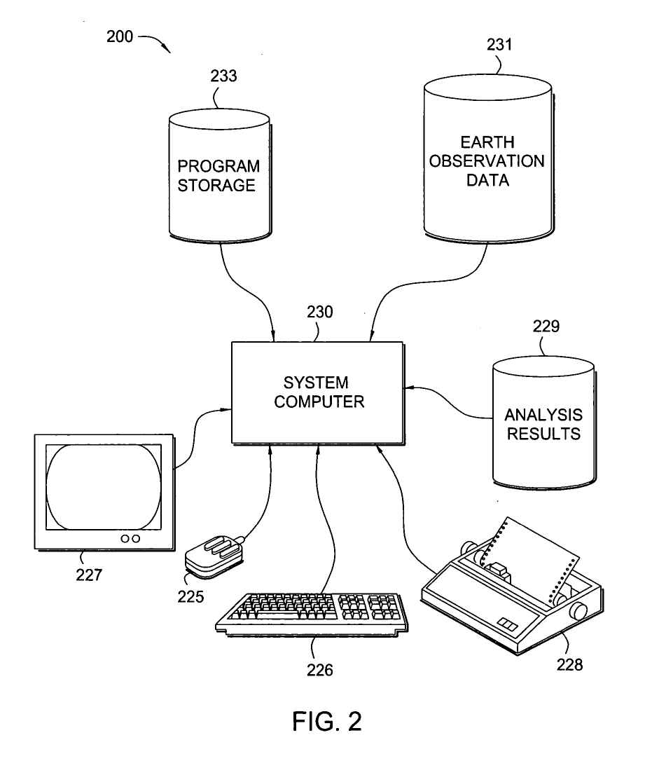

FIG. 2 illustrates a computer network 200, into which embodiments of the invention may be implemented. The computer network 200 includes a system computer 230, which may be implemented as any conventional personal computer or workstation, such as a LINUX-based workstation. The system computer 230 is in communication with disk storage devices 229, 231, and 233, which may be external hard disk storage devices. It is contemplated that disk storage devices 229, 231, and 233 are conventional hard disk drives, and as such, will be implemented by way of a local area network or by remote access. Of course, while disk storage devices 229, 231, and 233 are illustrated as separate devices, a single disk storage device may be used to store any and all of the program instructions, measurement data, and results as desired.

In one embodiment, earth observation data are stored in disk storage device 231. The system computer 230 may retrieve the appropriate data from the disk storage device 231 to perform the survey maps generation methods according to program instructions corresponding to various embodiments described herein. The program instructions may be written in a computer programming language, such as C++, Java and the like. The program instructions may be stored in a computer-readable memory, such as program disk storage device 233. Of course, the memory medium storing the program instructions may be of any conventional type used for the storage of computer programs, including hard disk drives, floppy disks, CD-ROMs and other optical media, magnetic tape, and the like.

According to the preferred embodiment of the invention, the system computer 230 presents output primarily onto graphics display 227, or alternatively via printer 228. The system computer 230 may store the results of the methods described above on disk storage 229, for later use and further analysis. As such, the survey maps may be stored in the disk storage 229, which may also be commonly referred to as the geographic information system (GIS) database. The keyboard 226 and the pointing device (e.g., a mouse, trackball, or the like) 225 may be provided with the system computer 230 to enable interactive operation.

The system computer 230 may be located at a data center remote from the survey region. The system computer 230 is in communication with equipment configured to receive the earth observation data. These data, after conventional formatting and other initial processing, may be stored by the system computer 230 as digital data in the disk storage 231 for subsequent retrieval and processing in the manner described above. While FIG. 2 illustrates the disk storage 231 as directly connected to the system computer 230, it is also contemplated that the disk storage device 231 may be accessible through a local area network or by remote access. Furthermore, while disk storage devices 229, 231 are illustrated as separate devices for storing earth observation data and analysis results, the disk storage devices 229, 231 may be implemented within a single disk drive (either together with or separately from program disk storage device 233), or in any other conventional manner as will be fully understood by one of skill in the art having reference to this specification

While the foregoing is directed to embodiments of the present invention, other and further embodiments of the invention may be devised without departing from the basic scope thereof, and the scope thereof is determined by the claims that follow.

1. A method for generating one or more maps of a survey area, comprising:
receiving earth observation data;
georeferencing the earth observation data with seismic data;
extracting one or more attributes from the earth observation data; and
displaying the extracted attributes.

2. The method of claim 1, wherein displaying the extracted attributes comprises plotting the extracted attributes on the maps.

3. The method of claim 1, further comprising calibrating the extracted attributes with seismic quality control data.

4. The method of claim 1, wherein the attributes comprise a digital terrain model.

5. The method of claim 4, wherein the attributes further comprise land use information.

6. The method of claim 4, wherein the digital terrain model provides a topography and surface gradient of the survey area.

7. The method of claim 4, wherein the digital terrain model is extracted from the earth observation data obtained from at least one of visible, near and mid infrared light.

8. The method of claim 5, wherein the land use information are extracted from the earth observation data obtained from at least one of visible, near and mid infrared light.

9. The method of claim 5, wherein the land use information comprise information regarding at least one of infrastructure, vegetation, rivers and mountains.

10. The method of claim 5, wherein the land use information and the digital terrain model are indicative of safety and accessibility of the survey area for seismic data acquisition.

11. The method of claim 1, wherein the attributes comprise information regarding rocks, each with a diameter greater than about 20 cm.

12. The method of claim 11, wherein the information regarding rocks are extracted from the earth observation data obtained from short wave infrared light.

13. The method of claim 11, wherein the information regarding rocks is indicative of locations within the survey area that are conducive to vibrator coupling and point loading problems.

14. The method of claim 1, wherein the attributes comprise information regarding soft ground.

15. The method of claim 14, wherein the information regarding soft ground comprises information regarding at least one of drainage patterns, wadis, sand dunes, sabkha, gypsum marshlands, and caliche horizons.

16. The method of claim 14, wherein the information regarding soft ground is extracted from the earth observation data obtained from short wave infrared light.

17. The method of claim 14, wherein the information regarding soft ground is extracted from the earth observation data obtained from thermal infrared light.

18. The method of claim 1, wherein calibrating the extracted attributes comprises correlating the extracted attributes with at least one of force and distortion information of the source signals and at least one of characteristic surface wave velocity, attenuation, resonance, magnitude and spectral characteristic of the receiver signals.

19. The method of claim 1, wherein the maps comprise a visible light image map illustrating land use information within the survey area.

20. The method of claim 1, wherein the maps comprise a roughness map illustrating information regarding rocks with a diameter exceeding 20 cm.

21. The method of claim 1, wherein the maps comprise a surface lithology map illustrating soft ground information within the survey area.

22. A method for planning a survey, comprising:
receiving earth observation data;
georeferencing the earth observation data with seismic data;
extracting one or more attributes from the earth observation data;
displaying the extracted attributes; and
using the maps to identify locations within the survey area that are prone to ground coupling problems for source and receivers.

23. The method of claim 22, wherein displaying the extracted attributes comprises plotting the extracted attributes on the maps.

24. The method of claim 22, further comprising calibrating the extracted attributes with seismic quality control data.

25. The method of claim 22, further comprising using the maps to identify unsafe and inaccessible locations within the survey area.
